(19) United States
(12) Patent Application Publication
(10) Pub. No.: US 2003/0120589 A1
(43) Pub. Date: Jun. 26, 2003

(54) Method and apparatus for risk analysis management and quality of service analysis

(75) Inventors: Hubert Williams, Baltimore, MD (US); Karen Amendola, Falls Church, VA (US); Edwin Hamilton, Silver Spring, MD (US); Ray Johnston, Laurel, DE (US); Ray Johnston JR., Swarthmore, PA (US); Eliab Tarkghen, Washington, DC (US); Yared Woldegebrial, South Riding, VA (US)

Correspondence Address: SUGHRUE MION, PLLC, 2100 Pennsylvania Avenue, NW, Washington, DC, 20037-3213, US

(73) Assignee: THE POLICE FOUNDATION

(21) Appl. No.: 10/174,818

(22) Filed: Jun. 20, 2002

Related U.S. Application Data
(60) Provisional application No. 60/341,251, filed on Dec. 20, 2001.

(51) Int. Cl. G06F 17/60

(52) U.S. Cl. 705/38; 705/8

(57) ABSTRACT

The database management system transforms personnel folders and incident/accident reports into charts to provide information needed to make decisions and to manage resources. The database management system detects certain identified behavior patterns of employees and performs risk analysis based on the detected patterns. The risk analysis outputs statistics that can then be used for counseling and/or intervention purposes.

### CROSS-REFERENCES TO RELATED APPLICATIONS

This application is an application filed under 35 U.S.C. §111(a), claiming benefit pursuant to 35 U.S.C. §120 of the filing date of the Provisional Application Serial No. 60/341,251 filed on Dec. 20, 2001, pursuant to 35 U.S.C. §111(b). The Provisional Application Serial No. 60/341,251 is herein incorporated by reference in its entirety.

### BACKGROUND OF THE INVENTION

1. Technical Field of the Invention

The present invention relates to an information management system for managing, analyzing and controlling information related to risk analysis and quality of service. In particular, the invention generates statistical analyses based on user-input criteria. The invention is embodied in a method, a computer system, and a computer program product that creates the information management system.

2. Description of the Related Art

Conventional personnel management systems manage, analyze and contro information related to risk analysis. In general, the conventional systems provide management with the capability to identify and track fields of data that would serve to alert management of problem behavior of employees. However, conventional management systems do not automatically alert management of problem behavior among individual employees when data was entered into the system or when accessing the system. The conventional systems also do not capture specific information on the corrective action or supervisory intervention taken with respect to the problem behavior, nor is there a mechanism in place for evaluating the total degree of risk for each risk category, i.e., a total risk quotient.

### SUMMARY OF THE INVENTION

The invention has been made in view of the above circumstances and to overcome the above problems and limitations of the prior art, and provides the capability of risk analysis management and quality of service indications based upon a user-specified information needed for generating reports and statistical analysis of risks and quality of service.

Additional advantages of the invention will be set forth in part in the description that follows and in part will be obvious from the description, or may be learned by practice of the invention. The advantages of the invention may be realized and attained by means of the instrumentalities and combinations particularly pointed out in the appended claims.

It is an aspect of the invention to provide a method, a computer system and a computer program product for risk analysis management system, wherein data is retrieved from database files, a plurality of risk analysis thresholds for application to the retrieved data are adjusted, a predefined report style is selected from a plurality of report styles, and the retrieved data is analyzed using the adjusted risk analysis thresholds, and the analysis is outputted in the predefined report style. The user chooses between various options for adding, editing, deleting and viewing data, whereby these options are used to select particular data tables from database files. The user chooses between various options for creating reports and statistics, whereby the reports and statistics are generated by manipulating and using various risk related factors selected from the database files.

The above aspects of the invention are further accomplished by providing a method, a computer system and a computer program product for a risk analysis management system, wherein the data comprises general personnel information, a photo and information specific to a police officer, a candidate, an applicant and a recruit in a police division.

The above aspects of the invention are of the invention are further accomplished by providing a method, a computer system and a computer program product for a risk analysis management system, wherein the information comprises data about officer's sick leaves, injuries and events such as vehicle pursuits, use of force incidents and vehicle accidents and wherein the reports comprise graphs, charts and composite reports based on a plurality of factors.

The above aspects of the invention are further accomplished by providing a method, a computer system and a computer program product for risk analysis management system, wherein the risk factors include number of use of force incidents and number of vehicle pursuits incidents and wherein the risk factors are evaluated by using threshold values set by the administrator.

It is a further aspect of the invention to provide a method, a computer system and a computer program product for quality of service indicator system, wherein data is entered into a database file, the database file is searched for specific data by using identification number of the specific data, the specific data is organized into a plurality of predefined categories, and a statistical analysis of the data is generated based upon the predefined categories. The user navigates between the categories by clicking on various tabs. Reports and statistics are generated by making a selection between various options and by setting various threshold values.

The above aspects of the invention are further accomplished by providing a method, a computer system and a computer program product for a quality of service indicator system, wherein the various options comprise all data pertaining to an officer or all data pertaining to a complaint and wherein various options include generating statistics by bureau and division, gender, race and age and by setting threshold values including data ranges and flag value to indicate officer's risk.

The above aspects of the invention are further accomplished by providing a method, a computer system and a computer program product for a quality of service indicator system, wherein the categories comprise vehicle information that contain data pertaining to a vehicle, officer information that contain data pertaining to an officer's contact with the community, complaint information that contain data pertaining to a complaint on an employee made by a person, complainant information that contain data pertaining to a person who made a complaint about an employee.

### BRIEF DESCRIPTION OF THE DRAWINGS

The accompanying drawings, which are incorporated in and constitute a part of this specification, illustrate aspects of the invention and, together with the written description, serve to explain the aspects, advantages and principles of the invention. In the drawings:

FIG. 1 illustrates an overall structure of an exemplary embodiment of the present invention, including the risk analysis management module and the quality of service indication module;

FIG. 2 illustrates an overall structure of an exemplary embodiment of the risk analysis management module according to the present invention;

FIG. 3A illustrates an exemplary embodiment, as it appears to the user, of the main menu of the risk analysis management module displayed in a toolbar presenting menu option in icon format;

FIG. 3B illustrates an exemplary embodiment, as it appears to the user, of the main menu of the risk analysis management module displayed in a tree structure navigation frame;

FIG. 4 illustrates an exemplary embodiment of the components of the risk analysis management module according to the present invention;

FIG. 5 illustrates exemplary embodiment of the quality of service indicator module according to the present invention;

FIG. 6 illustrates an exemplary process flow for data analysis and report generation; and

FIG. 7 illustrates an exemplary process flow for data entry and statistical analysis of entered data.

### DETAILED DESCRIPTION OF THE INVENTION

As used herein, the term “computer system” encompasses the widest possible meaning and includes, but is not limited to, standalone processors, networked processors, mainframe processors and processors in a client/server relationship. The term “computer system” is to be understood to comprise at least a memory and a processor. In general, the memory will store, at one time or another, at least portions of executable program code and the processor will execute one or more of the instructions included in that executable program code.

It will be appreciated that the term “predetermined operations,” the term “computer system software,” and the term “executable code” mean substantially the same thing for the purposes of this description. It is not necessary to the practice of this invention that the memory and the processor be physically located in the same place. That is to say, it is foreseen that the processor and the memory might be in different physical pieces of equipment or even in geographically distinct locations.

As used herein, one of skill in the art will appreciate that “media” or “computer-readable media” may include a diskette, a tape, a compact disc, an integrated circuit, a cartridge, a remote transmission via a communications circuit, or any other similar medium useable by computers. For example, to distribute computer system software, the supplier might provide a diskette or might transmit the instructions for performing predetermined operations in some form via satellite transmission, via a direct telephone link, or via the Internet.

Although computer system software might be “written on” a diskette, “stored in” an integrated circuit, or “carried over” a communications circuit, it will be appreciated that, for the purposes of this discussion, the computer usable medium will be referred to as “bearing” the instructions for performing predetermined operations. Thus, the term “bearing” is intended to encompass the above and equivalent ways in which instructions for performing predetermined operations are associated with a computer usable medium.

Therefore, for the sake of simplicity, the term “program product” is hereafter used to refer to a computer useable medium, as defined above, which bears instructions for performing predetermined operations in any form.

The present invention will now be described in detail by describing illustrative, non-limiting embodiments thereof with reference to the accompanying drawings. In the drawings, the same reference marks denote the same elements.

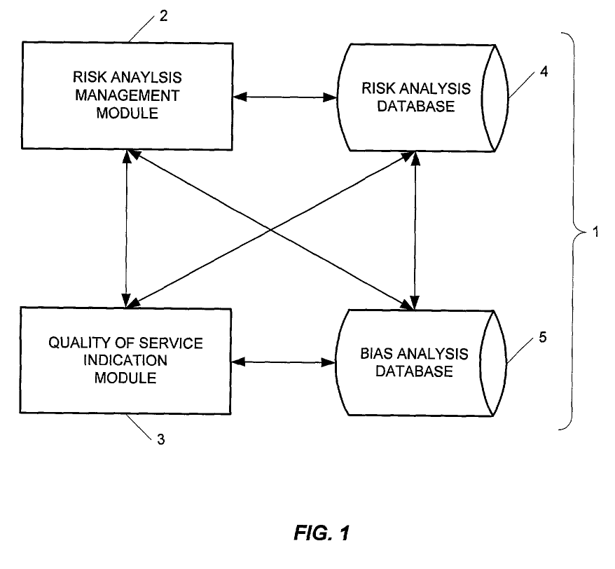

The present invention is a database management system, which manipulates data related to risk analysis management and quality of service indications based on user input. FIG. 1 illustrates an exemplary structure of the present invention. In FIG. 1, the exemplary embodiment of the present invention is comprised of a risk analysis management module 2, a quality of service indicator module 3, a risk analysis management database 4 and a bias database 5. The modules and databases are interconnected by data links 6. The risk analysis management module 2 performs the risk analysis functions and can call the quality of service indicator module 3. The quality of service indicator module 3 can be executed separately as well. Preferably, the present invention uses ActiveX Data Objects to connect to the risk analysis database 4 and the bias database 5, and these databases can be implemented as Access 2000 data files. Both the risk analysis management module 2 and the quality of service indicator module 3 manipulate data (e.g., storing new data, editing existing data, reading and analyzing data) in the risk analysis database 4 and the bias database 5.

The risk analysis management module 2 and the quality of service indicator module 3 are preferably implemented using Visual Basic. The present invention utilizes Visual Basic run time libraries, crystal reports and data report library.

In one embodiment of the present invention, police departments can use the risk analysis management module 2 and the quality of service indicator module 3 to assist them in management of their data. The concepts of the present invention are applicable for personnel management in other fields as well, e.g., medicine, etc. However, in order to illustrate the concepts of the present invention, this disclosure will focus on using the present invention in a police department context. The risk analysis management module 2 transforms personnel data and incident/accident reports into charts to provide information needed to make decisions, manage resources and respond to crisis. For example, the risk analysis management module 2 enables a police department to detect when an officer has used excessive sick leave or has excessive use of force incidents. The present invention allows management to implement effective intervention techniques, such as suspend the officer. The present invention can assist municipalities to minimize legal liability and costly litigation by providing the municipality with statistical analysis of factors that place municipal interests at risk. For instance, a municipality can detect when a certain bureau or division within the police department has engaged in excessive vehicle pursuit incidents in which a civilian or an officer was injured.

The present invention allows municipalities to assess risk related activity, to make comparisons (e.g., between personnel or between divisions within the police department) to produce reports that can improve accountability, show areas where improvement maybe needed, enhance service quality and minimize legal liability. Similarly, the quality of service indicator module 3 is designed to help police departments to maximize effective community relations, build accountability and reduce liability through improved officer performance. The quality of service indicator module 3 delivers reports based on collection and analysis of police-citizen encounters, such as traffic stops.

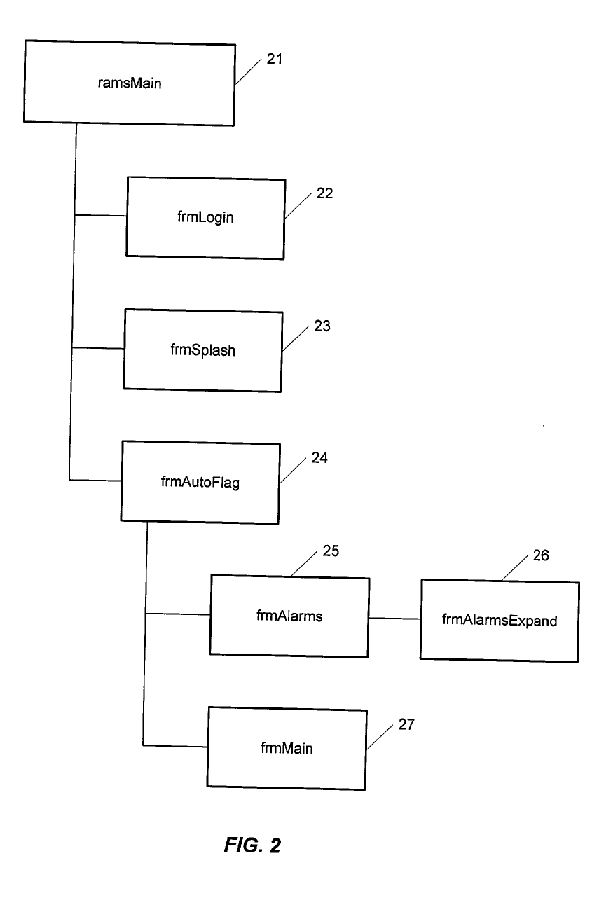

Referring to FIG. 2, an exemplary structure of the risk analysis management module 2 is shown. Once the user executes the risk analysis management module 2, the ramsMain software component 21 initializes system parameters and executes the frmLogin software component 22. Once a user identification and a password has been input, the ramsMain software component 21 verifies the inputted data with data stored in the bias database 5 (to be discussed later). If a match is found, the frmSplash software component 23 is executed. The frmSplash software component 23 can be a progress bar or some other form, also commonly known as a window, presented for user verification while the system checks for new alarms and loads the required frmAutoFlag software component 24. For instance, if new alarms are not detected, the corresponding message is displayed, and since no new alarms are detected, the program enters the frmMain software component 27 by opening the form with main menu. If new alarms are present, the frmAutoFlag software component 24 displays a confirmation form. The user can view the new alarms by clicking “yes” button. When “yes” button is clicked, the frmAlarms software component 25 is executed, which shows all items in the alarm queue. Each item can be expanded to show detailed information about the item in the frmAlarmExpand software component 26. Afterwards, the risk analysis management module 2 enters the frmMain software component 27 by opening the form with main menu (described below).

Similarly, if quality of service indicator module 3 is executed independently from risk analysis management module 2, then, the quality of service indicator module 3 executes a login form, which presents a user with login screen. If the user login is successful, the main menu of quality of service indicator module 3 is executed and displayed to the user. Alternatively, if the quality of service indicator module 3 is executed through risk analysis management module 2, then the program immediately enters into the main menu of quality of service indicator module 3 and displays the main menu to the user.

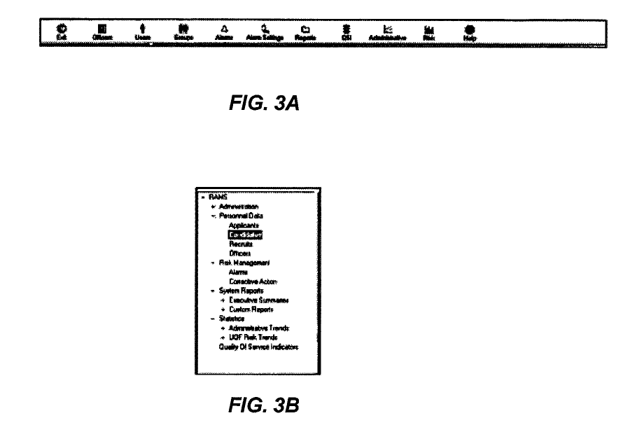

FIGS. 3A and 3B show the menu options for the risk analysis management module 2. The user sees these menu options upon successful login into the risk analysis management module 2. The user can navigate through the risk analysis management module 2 either by clicking icons in the toolbar, as shown in FIG. 3A, or by clicking menu options shown in a tree structure navigator frame, as shown in FIG. 3B. The first menu option in the tree structure navigation frame is Administration, as shown in FIG. 3B. This menu option is specifically designed for an administrator who will input all the initial information into the present invention and update the databases. For instance, the administrator can click the icon “user” on the toolbar, as shown in FIG. 3A, or click on the User Access option appearing under Administration in the tree structure navigator frame. This allows the administrator to add and delete users, update their information, and change user access rights. The dialog boxes and/or displays with the appropriate fields, pull-down menus, or other graphical display tools to implement this menu option are not shown, as one of ordinary skill in the art can easily design these dialog boxes and/or displays.

Under the Administration menu option appearing in the tree structure navigator frame, the administrator can choose group access menu option (alternatively, administrator can click on the icon “groups”, located on the toolbar as shown in FIG. 3A). The administrator can add and delete groups of users, e.g., police bureaus and/or police divisions, command personnel, etc., and to modify the group access rights as well. Again, the dialog boxes and/or displays with the appropriate fields, pull-down menus, or other graphical display tools to implement this menu option are not shown, as one of ordinary skill in the art can easily design these dialog boxes and/or displays.

Next, the administrator can set alarms by selecting the alarm thresholds menu option under the Administration menu option appearing in the tree structure navigator frame (alternatively, by clicking on “Alarms Setting” icon, located on the toolbar as shown in FIG. 3A). The alarm thresholds menu allows the administrator to set flag values by selecting number of incidents, type of flag (e.g., yellow for possible problems and red for serious problems), and date ranges in several categories (e.g., complaints, injury, leave, sick leave, pursuits, vehicle accidents, use of force incidents, etc.). The categories will be described in more detail below. Again, the dialog boxes and/or displays with the appropriate fields, pull-down menus, or other graphical display tools to implement this menu option are not shown, as one of ordinary skill in the art can easily design these dialog boxes and/or displays.

In addition, the administrator can establish degree of risk (weights) by selecting total risk quotient threshold menu item under the Administration menu option appearing on the tree structure navigator frame (alternatively, by clicking on “Administration” icon, located on the toolbar as shown in FIG. 3A). The total risk quotient threshold menu item allows the administrator to adjust total risk quotients for groups of individuals in the database (i.e., police bureaus or police divisions), or for all individuals in the database (i.e., the entire police department). Data that would be used for the total risk quotient threshold would include complaints, injuries, vehicle pursuits, used sick leave, use of force incidents and vehicle accidents. Other categories can be added to the total risk quotient as necessary. The dialog boxes and/or displays with the appropriate fields, pull-down menus, or other graphical display tools to implement this menu option are not shown, as one of ordinary skill in the art can easily design these dialog boxes and/or displays, as well as facilitate the data entry necessary for the total risk quotient.

The second menu option in the tree structure navigator frame is Personnel, as shown in FIG. 3B. Alternatively, the user can click “officers” icon located on the toolbar shown in FIG. 3A. The user can select the desired person by last name or by ID number or can add a new person, provided the user has access rights. If such person is found in the database, the present invention can display personal information, such as the person's picture, identification number, first, middle and last names, social security number, birth date, height, weight, marital status, race, status within the police department (applicant, candidate, recruit, officer), education level, home address, etc. The present invention can also display information specific to the person's status as well. For instance, if the person is an police officer, then the present invention can extract a badge number, commander and supervising unit, data of appointment, present command and assignment, rank, number of use of force incidents, sick leave history, injury history and vehicle history, assigned bureau and division, etc. from the risk assessment database 4. If the present invention present invention is used for analysis of a police department, it provides a field that lists an officer's use of force incidents, vehicle pursuit incidents, sick leave history, injury history and vehicle history. Alternatively, if a person in the database is an applicant for a particular job, the present invention will extract and display various categories of information, e.g., the applicant's identification number, application date, written examination score, number and rank on the list of applicants, physical, medical and psychological examination results. Other information could include criminal and juvenile offenses, financial obligations, number of violent incidents, date of evaluation, evaluation results, awards, date of last award, total number of awards, physical performance average, educational background, courses type, academic grade point average, etc.

Alternatively, the user can select applicant, candidate, recruit or officer under the tree structure navigator frame shown in FIG. 3B, and search the officer, by last name or identification number. Then, the form specific to the person's status (e.g., officer, applicant, candidate or recruit) will be loaded, surpassing the person's general information form.

The third menu option in the tree structure navigator frame is risk management, as shown in FIG. 3B. Alternatively, the user can click “risk” icon on the toolbar shown in FIG. 3A. This menu option deals with specific incidents in categories of use of force, vehicle accidents, high-speed pursuits, sick leave and injuries. Once the user clicks on the icon “risk” or chooses the option risk management, the present invention displays a case identification form showing the case identification number and the date of the incident is shown. The user can select a case and then load and view the detailed information for this specific incident. The detailed information will be different in each category.

For instance, in the category of use of force incidents, the present invention can display the incident's general information, its characteristics, its identification page and its outcome. For vehicle accident information, the present invention can display an accident case number, the accident date and pursuit case number, as well as accident information (general information), accident location and accident outcome. For vehicle pursuit cases, the present invention can display pursuit incidents by pursuit case number, incident case number and pursuit date, wherein detailed information on a selected pursuit incident is available. For the sick leave case category, the present invention can display particular sick leave information can be viewed by selecting sick date, working day and number of hours. Similarly, the injury category provides details about a particular injury by the user selecting injury date, working day and number of hours. For each category of information displayed, additional information can be added based on a particular user's requirements. The dialog boxes and/or displays with the appropriate fields, pull-down menus, or other graphical display tools to implement this menu option are not shown, as one of ordinary skill in the art can easily design these dialog boxes and/or displays, as well as facilitate the data entry.

The fourth menu option in the tree structure navigator frame is system reports, as shown in FIG. 3B. Alternatively, the user can click “reports” icon on the toolbar as shown in FIG. 3A. This menu option deals with generating system reports such as executive summaries and custom reports. The executive summary reports allow the user to generate a report of risks associated with an officer's personnel data. The reports allow the user to view all pertinent data associated with an officer's use of force incidents, vehicle accidents, hot pursuits incidents, sick and injury leaves, etc. The user selects an officer by identification number or by the officer's last name, then the user selects the type of risk report to generate within a particular time frame. The user can print, view or cancel the selected report. Finally, custom reports provide a summary report of an officer's performance with all the risk factors included.

The fifth menu option in the tree structure navigator frame is statistics, as shown in FIG. 3B. Alternatively, the user can click “administrative” icon on the toolbar as shown in FIG. 3A. This menu option deals with generating administrative trends and use of force risk trends. Administrative trends generate statistics for use of force by an employee, by a supervisor, by a commander or by bureau/division. Alternatively, administrative trends can generate statistics by using a particular risk factor, such as generating statistics by vehicle accidents, by sick/injury leaves or by hot pursuit incidents. The statistics is generated in accordance with the red/yellow threshold values set by the user.

Furthermore, the use of force risk trends provide statistics for various administrative and geographic trends of use of force incidents. The user can select various risk factors and start and end date for reports. In particular, various risk factors under the risk statistics can be used, e.g., the criminal code (the frequency distribution of the criminal code that was applicable to the event), a person's rank (either commander's, supervisor's, or the officer's), the duty status (number of officers involved in accordance to their duty status, off or on duty), number of units present (number of officers present), city type, assignment type (use of force in accordance with the specific duty assignments), command type, etc. Also, the user can generate statistics by choosing additional risk factors, e.g., type of force used, assault type, patrol sector, weather, race, age and gender of the police officers.

The sixth menu option in the tree structure navigator frame is quality of service indicator, as shown in FIG. 3B. Alternatively, the user can click “QSI” icon on the toolbar shown in FIG. 3A. Once the user selects this menu option, the risk analysis management module 2 calls and executes the quality of service indicator module 3. The quality of service indicator module 3 uses a tree structured navigation menu with two main menu options: data entry and report. In the data entry menu option, data is added, deleted, edited and viewed. The data entry menu option has seven categories for storing information, which correspond to seven tabs (alternatively, these categories are displayed under the data entry menu option in the tree structure navigation menu). The user finds specific data in these different categories by using case/contact/call number field (depending on the category). The present invention can display one or more types of contact information between a civilian and an officer, vehicle information, officer information, civilian information, e.g., arrested persons, complaint information, e.g., criminal conduct or investigation, displays complainant information, or officer's personal information (this is identical to data displayed in a officer's information form, under personnel menu option in the risk analysis management module 2 system).

The second menu option of the quality of service indication module 3 is used for generating reports and statistical analysis. Under this menu option, the user can adjust the flags by setting different weights to various risk factors and the user can choose different date ranges.

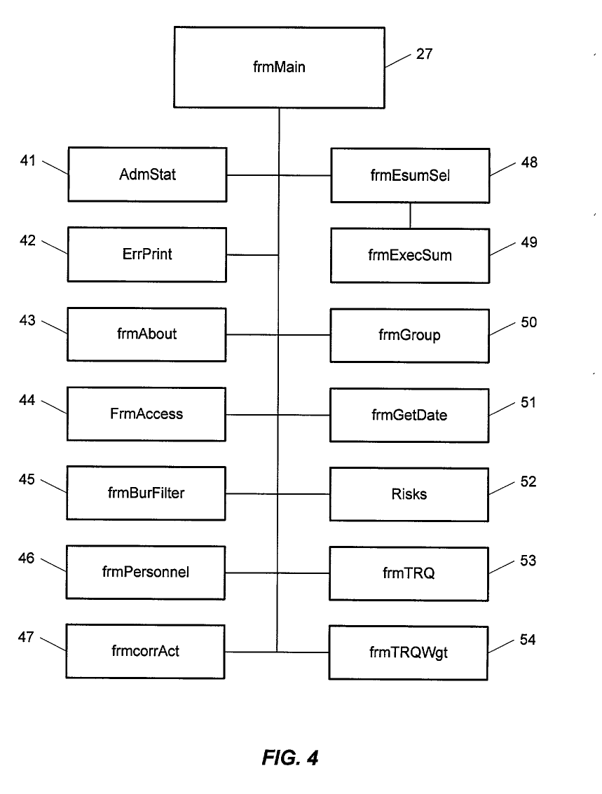

Now, the back end of the system will be described. To begin, two files, a risk analysis database 4 and bias database 5, store data needed for the risk analysis management module 2 and the quality of service indicator module 3. In the risk analysis management module 2, the frmMain software component 27 contains all major functions and menu options specific to the risk analysis management module 2. These functions, forms and menu options can be executed in random order. Major forms and functions executed by the frmMain software component 27 are shown in FIG. 4. First, the frmMain software component 27 can execute (a) the frmAdmStat software component 41 for generating statistical reports; (b) the ErrPrint software component 42 for displaying error messages; (c) the frmAbout software component 43 that displays application information, about the application; (d) the frmAccess software component 44 to establish privileges for specific groups; (e) the frmBurFilter software component 45 to indicate the filtering processes between the bureaus and divisions. The frmMain software component 27 also executes the frmPersonnel software component 46 for viewing and editing individual personnel information.

In addition, the frmMain software component 27 can execute the frmcorrAct software component 47 for allowing the user to edit and view alarm corrective action information, as well as the frmEsumSel software component 48 which is an executive summary selection used for choosing the type of report to generate. The frmEsumSel software component 48 executes the frmExecSum software component 49, which generates reports by manipulating various risk factors or generating composite reports.

In addition, the frmMain software component 27 can execute the frmGroup software component 50 for adding, deleting and updating groups to the system, as well as the frmGetDate software component 51 used for getting the date ranges to be used to generate composite and risk factor reports. The frmMain software component 27 also executes risks software component 52, which is a risk statistics form for generating specific use of force reports. Finally, the frmMain software component 27 executes the frmTRQ software component 53 in order to display a Total Risk Quotient report and to flag officer based on established criteria set by administrator and the frmTRQWGT software component 54 for initializing and setting up the weight for Total Risk Quotient reports.

Also, the frmMain software component 27 executes all the menu options for risk analysis management module 2 as well as a special node for displaying tree structure navigator menu and special command to execute menu options upon a mouse click on an icon on the toolbar or on an option in the tree structure navigator tree. Also, the rain software component 27 contains exit command and help menu options to help the user use the risk analysis management module 2.

Menu options are executed by loading the appropriate forms and the corresponding data tables. More complicated relationships exist between personnel tables and personnel menu options. The data can be uploaded for viewing, changing, deleting or adding applicants; these operations are implemented by corresponding functions in the frmPersonnel software component 46; these functions perform operations that modify the tables. In addition, the frmPersonnel software component 46 contains functions for adding, updating and viewing case information used under the “risk” icon or risk management option. The risk management database 4 stores this personnel information, as well as information relating to pertaining to accidents, hot pursuits incidents, injury incidents and sick leave use.

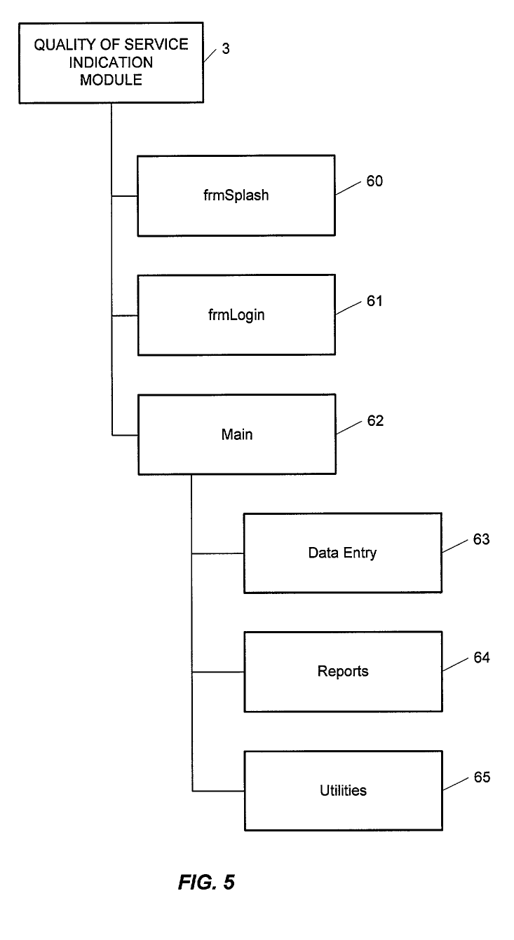

The general structure of the quality of service indicator module 3 is shown in FIG. 5. If quality of service indicator module 3 is executed separately from risk analysis management module 2, then the frmSplash software component 60 and the frmLogin software component 61 are loaded. These forms are similar to the frmSplash software component 23 and the frmLogin software component 22 in risk analysis management module 2, described hereinabove. Once, the user calls quality of service indicator module 3 from risk analysis management module 2 system or upon successful login when quality of service indicator module 3 is executed separately, the Main software component 63 is loaded. The Main software component defines all the menu options in a tree structure. First header is Data Entry 64, which is used to collect contact information during the stop (time, date, reason for stop, arrest, search, injury and outcome of contact), the officer's information such as Bureau, division and their role during contact, the citizen information such as demographic, outcome of contact, search and arrest, vehicle information such as make, type, year and model of the vehicle and information about search and seizure of items during contact, information about the complaint of a citizen such as date, type, status, type of allegations and the outcome, and complaint information such as demographic information of the complainant, bureau and division, identification number of the person who received the complaint as well as an option for checking whether the complaint is internal or external. The second header is Reports 65, which allows the user to choose report type (complaint, contact and general report) and allows the users to view reports for crystal reports. The third header is Utilities 67, which contains options that are used for documenting program errors (e.g., generating an error log file). Reports are generated by loading required tables from the risk analysis database 4 and displaying the reports, the design for generating these reports are described in detail under risk analysis management module 2 design.

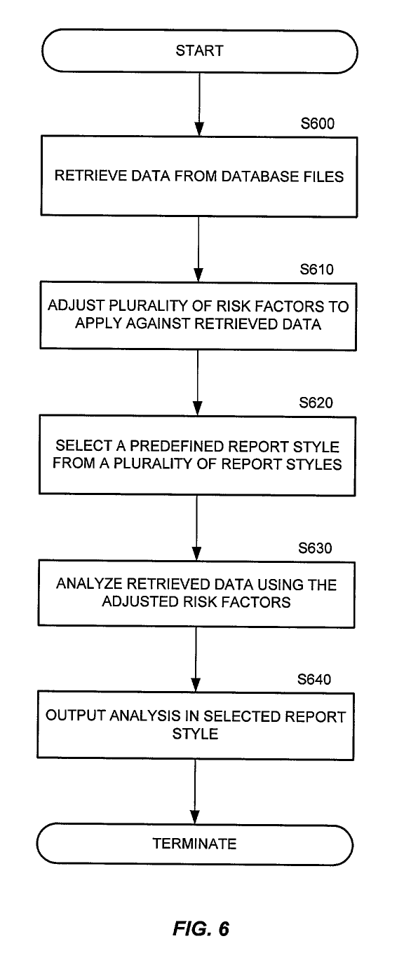

Referring to FIG. 6, an exemplary process flow is illustrated for the present invention. At S600, data is retrieved from the database files, i.e., the risk analysis database 4 and/or the bias analysis database 5. As described above, this data can pertain to an entire department, or can pertain to targeted individuals and/or groups of the individuals. At S610, the operator of the present invention adjusts the plurality of risk factors (i.e., pursuits, use of force, sick leave usage, etc.) for application against the data that was retrieved from the database files. Next, at S620, the operator selects the report style that will be used for the analysis of the retrieved data. At S630, the retrieved data undergoes a statistical nalysis using the adjusted risk factors (See S610). Although not shown in FIG. 6, if the operator wishes to further adjust the plurality of risk factors such that the operator can more closely evaluate a particular data set, this analysis can be executed repeatedly. Finally, as S640, the statistical analysis is output in the report style that was selected in S620. This exemplary method for the present invention is also embodied in a computer system comprising a processor, and a memory comprising software instructions adapted to enable computer system to perform tasks. Alternatively, this exemplary method for the present invention is also embodied as a computer program product that comprises software instructions for enabling the computer to perform predetermined operations, and a computer readable medium bearing the software instructions.

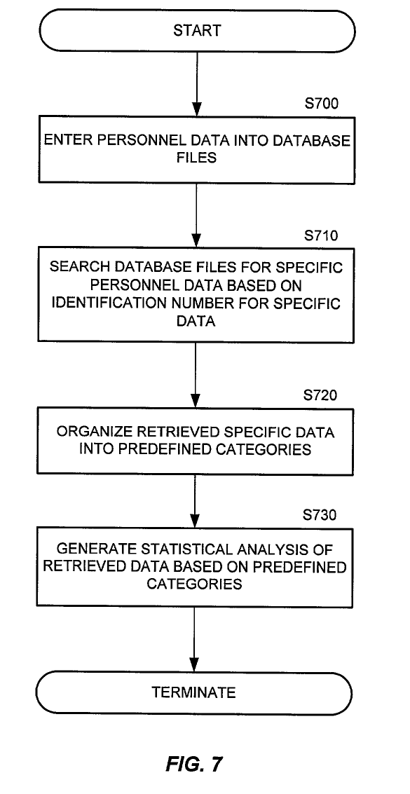

Referring to FIG. 7, another exemplary process flow according to the present invention is illustrated. For quality of service indication, at S700, the personnel data is entered into the database files, i.e., the risk analysis database 4 and/or the bias analysis database 5. Again, the type of data that is entered into the database files has been described above. Next, at S710, the database files are searched for specific personnel data based on the identification number for a specific data type. Once the specific data has been retrieved, at S720, the retrieved data is organized into specific predefined categories, e.g., race, gender, etc. Again, these categories have been described in detail above. At S730, the present invention generates a statistical analysis of the retrieved data based upon the predefined categories, into which the retrieved data has been sorted. At the conclusion of the statistical analysis, the results are output in report form (not shown in FIG. 7). This exemplary method for the present invention is also embodied in a computer system comprising a processor, and a memory comprising software instructions adapted to enable computer system to perform tasks. Alternatively, this exemplary method for the present invention is also embodied as a computer program product that comprises software instructions for enabling the computer to perform predetermined operations, and a computer readable medium bearing the software instructions.

The foregoing description of the embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

Thus, while only certain embodiments of the invention have been specifically described herein, it will be apparent that numerous modifications may be made thereto without departing from the spirit and scope of the invention. Further, acronyms are used merely to enhance the readability of the specification and claims. It should be noted that these acronyms are not intended to lessen the generality of the terms used and they should not be construed to restrict the scope of the claims to the embodiments described therein.

What is claimed is:

1. A method for performing risk analysis, the method comprising:
retrieving data from database files;
adjusting a plurality of risk analysis thresholds for application to the retrieved data;
selecting a predefined report style from a plurality of report styles; and
analyzing the retrieved data using the adjusted risk analysis thresholds, and outputting the analysis in the predefined report style.

2. The method as set forth in claim 1, wherein the data comprises at least one of general employee information, photographic information and information specific to employee performance.

3. The method as set forth in claim 2, wherein the information specific to employee performance comprises at least one of sick leave data and employee injury data.

4. The method as set forth in claim 2, wherein the employee is a police officer.

5. The method as set forth in claim 4, wherein the information specific to employee performance comprises information about vehicle pursuits.

6. The method as set forth in claim 4, wherein the information specific to employee performance comprises information about use of force incidents.

7. The method as set forth in claim 4, wherein the information specific to employee performance comprises information about vehicle accidents.

8. The method as set forth in claim 1, wherein the risk analysis thresholds comprise a first predetermined value representing a number of use of force incidents and a second predetermined value representing a number of vehicle pursuit incidents.

9. The method as set forth in claim 1, wherein the risk analysis thresholds are evaluated by using threshold values set by an administrator.

10. A method for measuring quality of service, comprising:
entering data into a database file;
searching the database file for specific data by using identification number of the specific data;
organizing the specific data into a plurality of predefined categories; and
generating a statistical analysis of the data based upon the predefined categories.

11. The method as set forth in claim 10, wherein the data comprises at least one of general employee information, photographic information and information specific to employee performance.

12. The method as set forth in claim 11, wherein the employee is a police officer.

13. The method as set forth in claim 12, wherein the plurality of predefined categories comprises at least one of all data pertaining to officers, all data pertaining to complaints, all data pertaining to a police bureau, and all data pertaining to a police division.

14. The method as set forth in claim 12, wherein the statistical analysis is generated based on at least one of a police bureau and a police division.

15. The method as set forth in claim 14, wherein the statistical analysis comprises data analyzed by gender.

16. The method as set forth in claim 14, wherein the statistical analysis comprises analyzed by race.

17. The method as set forth in claim 14, wherein the statistical analysis comprises data analyzed by age.

18. The method as set forth in claim 12, wherein generating a statistical analysis further comprises selecting risk analysis thresholds for application to the specific data.

19. The method as set forth in claim 12, wherein the plurality of predefined categories comprises a category that contains information pertaining to a vehicle.

20. The method as set forth in claim 12, wherein the plurality of predefined categories comprises a category that contains information pertaining to a police officer's contact with the community.

21. The method as set forth in claim 12, wherein the plurality of predefined categories comprises a category that contains information pertaining to a complaint on an employee made by a person.

22. The method as set forth in claim 12, wherein the plurality of predefined categories comprises a category that that contains information pertaining to a person who made a complaint about an employee.

23. A computer system adapted for a risk analysis management system, comprising:
a processor;
a memory comprising software instructions adapted to enable computer system to perform tasks, wherein the software instructions comprise:
retrieving data from database files;
adjusting a plurality of risk analysis thresholds for application to the retrieved data;
selecting a predefined report style from a plurality of report styles; and
analyzing the retrieved data using the adjusted risk analysis thresholds, and outputting the analysis in the predefined report style.

24. A computer system adapted to create quality control indicator, comprising:
a processor;
a memory comprising software instructions adapted to enable computer system to perform tasks, wherein the software instructions comprise:
entering data into a database file;
searching the database file for specific data by using identification number of the specific data;
organizing the specific data into a plurality of predefined categories; and
generating a statistical analysis of the data based upon the predefined categories.

25. A computer program product for enabling a computer to create risk analysis management system, comprises:
software instructions for enabling the computer to perform predetermined operations, and a computer readable medium bearing the software instructions, wherein the predetermined operations comprise:
retrieving data from database files;
adjusting a plurality of risk analysis thresholds for application to the retrieved data;
selecting a predefined report style from a plurality of report styles; and
analyzing the retrieved data using the adjusted risk analysis thresholds, and outputting the analysis in the predefined report style.

26. A computer program product for enabling a computer to create quality control indicator system, comprises:
software instructions for enabling the computer to perform predetermined operations, and a computer readable medium bearing the software instructions, wherein the predetermined operations comprise:
entering data into a database file;
searching the database file for specific data by using identification number of the specific data;
organizing the specific data into a plurality of predefined categories; and
generating a statistical analysis of the data based upon the predefined categories.
